(19) United States
(12) Patent Application Publication
(10) Pub. No.: US 2014/0289299 A1
(43) Pub. Date: Sep. 25, 2014

(54) System and Method for Statistical Process Control

(71) Applicant: Paris Mountain Consulting, LLC, Greenville, SC (US)

(72) Inventor: Gregory Valente, Greenville, SC (US)

(73) Assignee: Paris Mountain Consulting, LLC, Greenville, SC (US)

(21) Appl. No.: 14/210,973

(22) Filed: Mar. 14, 2014

Related U.S. Application Data
(60) Provisional application No. 61/804,209, filed on Mar. 22, 2013.

(51) Int. Cl. G06F 5/00

(52) U.S. Cl. CPC G06F 5/00
USPC 708/442

(57) ABSTRACT

Systems and methods for statistical process control are provided. A computer implemented statistical process control method includes converting a plurality of data points to a plurality of Cartesian coordinate sets, determining a centroid for the plurality of Cartesian coordinate sets, calculating a distance from each of the plurality of Cartesian coordinate sets to the centroid, and establishing an ellipsoidal control zone based on the plurality of distances.

This application claims priority to U.S. Provisional Patent Application Ser. No. 61/804,209, filed Mar. 22, 2013, entitled “Method for Multivariable Statistical Process Control”, which is hereby incorporated by reference in its entirety.

### TECHNICAL FIELD

A portion of the disclosure of this patent document contains material which is subject to copyright protection. The copyright owner has no objection to facsimile reproduction by anyone of the patent document or the patent disclosure, as it appears in the Patent and Trademark Office patent file or records, but otherwise reserves all other copyright rights whatsoever. The following notice applies to the drawings that form a part of this document: Copyright © 2013 Paris Mountain Consulting, LLC. All rights reserved.

This invention relates to a method for simultaneously analyzing multiple variables for the purpose of understanding and controlling process variability, and more particularly, to a computer method and system for analyzing and controlling multiple variables.

### BACKGROUND OF THE INVENTION

Statistical process control (SPC) methods have been used for the purpose of analyzing and controlling the variability of manufacturing processes since the early 20th century. The end goal of these methods is predictability of process performance, whereby future performance can be reliably determined from an analysis of past and present performance. Often, a control loop is implemented for this purpose, where process variables are continuously monitored and analyzed in search of data anomalies, which serve as indicators of non-normal process trends.

When multiple process variables are present, as is often the case, it becomes difficult to determine cause and effect relationships between the multiple variables and their independent contributions and influences on the overall process.

A fundamental SPC technique consists of calculating a mean and standard deviation, σ, for a population of measurements for a process variable during an initial, or baseline, study of the process. Upper and Lower Control Limits are then established at intervals of +/−n*σ about the mean value, where n is typically a value from 1 to 6, representing confidence intervals according to a normal Gaussian distribution of possible data values. An interval of +/−3σ, for instance, represents a confidence interval of 99.73%.

Often, multiple process variables are measured, analyzed, and tracked independently of each other on several control charts, which may be implemented manually on paper charts or using a software program designed specifically for this purpose.

It's desirable to be able to combine several process variables into a single metric so that the overall performance of the process is well understood without having to independently check and verify that each individual variable is in control. One example of this need is in the qualification and analysis of a coordinate measuring machine, where each axis moves independently of the others, but where the repeatability and reproducibility of a final position or location is important. In this example, combining the x, y, z ordinate motions into a single, measureable value would be highly beneficial so that an overall confidence interval for the machine could be established.

Another example is the analysis of repeatability of a circular geometry inspection machine, where polar results data (r, Θ) are generated, for example for a roundness or eccentricity measurement. In order to analyze the repeatability and reproducibility of this polar data, consideration must be given to both the magnitude, r, and direction, Θ, of the data.

FIG. 1 shows a traditional approach to this analysis. In this traditional approach, the magnitudes 100 of the data points are first considered, and a mean and standard deviation are calculated for the magnitudes. An upper magnitude control limit 102 and lower magnitude control limit 104 are then established. Next, the angles 106 of the data points are considered, a mean and standard deviation are calculated for the angles, and an upper angular control limit 108 and lower angular control limit 110 are established. Data is thenceforth accepted or rejected based on the magnitude control zone 112 and the angular control zone 114 established by these pairs of upper and lower control limits.

Two out-of-control data points are shown. The first out-of-control point 116 falls within the magnitude control zone 112, but outside of the angular control zone 114. Conversely, the second out-of-control point 118 falls within the angular control zone 114, but outside of the magnitude control zone 112. In-control point 120 falls within both the magnitude and angular control zones.

A disadvantage of this traditional method is its inconsistency in application between several sets of data which may have identical shape and size. FIG. 2 shows a data set identical in size and shape as the data set of FIG. 1, but positioned closer to the origin. Though the magnitude control zone 212 (as defined by an upper control limit 202 and a lower control limit 204) and the angular control zone 214 (as defined by an upper control limit 208 and a lower control limit 210) widths are the same as the magnitude control zone 112 and angular control 114 zone widths of FIG. 1, more points now fall outside the boundaries of the angular control zone. In order to maintain the same number of in-control points between the two identical sets of data, the upper angular control limit 208 and lower angular control limit 210 would have to be widened, as shown by new upper angular control limit 216 and new lower angular control limit 218.

Another disadvantage of this traditional approach occurs when the data set of FIGS. 1 and 2 is further moved and centered at the origin, as shown in FIG. 3, and application of the traditional method becomes even more inconsistent. The magnitudes of the data points, which by definition cannot be negative, are now artificially and arbitrarily bounded by a lower value of zero. This causes the standard deviation of the magnitudes to become smaller, changing the distance between the upper magnitude control limit 302 and lower magnitude control limit 304, which makes the magnitude control zone 312 smaller than control zones 112, 212 for data sets that have identical size and shape. At the same time, because the angles of the data points now vary from 0 to 360 degrees, the standard deviation of the angles becomes so large that the angular control zone 314 becomes unbounded.

This inconsistency likewise appears when considering cylindrical or spherical coordinate data, where a third dimension is added.

In U.S. Pat. No. 6,088,622, Wang considers similar limitations to the analysis of polar coordinate data for the purpose of combining entities and proposes a solution whereby: a linear standard deviation and linear mean value are calculated for the magnitude data; and a circular standard deviation and directional mean value are calculated for the angular data, using a different method. He further argues and states in the detailed description of the patent that “a statistical analysis can only be performed on the r and Θ coordinate data in the Polar coordinate system,” and he concludes that “the statistical analysis method of the Cartesian coordinate system should not be chosen for the analysis as it generates an untrue mean from a set of data collected on the circumference.”

By employing the method of the present invention, the aforementioned disadvantages and limitations of both the tradition method and of Wang's Polar Coordinate method are avoided, and data in multiple dimensions can be combined in a statistically consistent manner regardless of the original coordinate system.

### BRIEF DESCRIPTION OF THE INVENTION

Aspects and advantages of the invention will be set forth in part in the following description, or may be obvious from the description, or may be learned through practice of the invention.

The present disclosure is a method for the statistical analysis of multi-variable data, where an ellipsoidal control zone is used to define a universe of statistically in-control data values. Data points in various coordinate systems—Cartesian, Polar, Cylindrical, Spherical, for example—are transformed to their Cartesian coordinate representation, defining a Cartesian location for each point. A mean location for the Cartesian data is then calculated, and the distances from each of the data points to this mean location is determined. The mean and standard deviation of these distances is then calculated and an ellipsoidal control zone, centered at the mean location, is established. The ellipsoidal control zone may, for example, be spherical. In one embodiment, the radius of the ellipsoidal control zone is the mean distance plus one or more standard deviations of the distances, though others are contemplated. Subsequent data points are then evaluated based on their distance to the mean location and whether or not they fall within the ellipsoidal control zone.

In one embodiment, the present disclosure provides a computer implemented statistical process control method. The method includes converting a plurality of data points to a plurality of Cartesian coordinate sets, determining a centroid for the plurality of Cartesian coordinate sets, calculating a distance from each of the plurality of Cartesian coordinate sets to the centroid, and establishing an ellipsoidal control zone based on the plurality of distances.

The establishing step may, for example, include calculating an average distance for the plurality of distances, and establishing a mean boundary based on the average distance. The mean boundary may, for example, have a radius equal to the average distance.

The establishing step may, for example, additionally or alternatively include calculating a standard deviation for the plurality of distances, and establishing a control surface based on the standard deviation. The control surface may, for example, have a radius equal to an average distance for the plurality of distances plus a total of the standard deviation times a deviation factor. The deviation factor may for example be less than or equal to 6.

The method may further include the step of evaluating at least one of the plurality of data points based on a location of the data point relative to the control surface.

In some embodiments, the control zone is established based on an average distance and a standard deviation for the plurality of distances. In some embodiments, the method further includes evaluating at least one of the plurality of data points based on the control zone. In some embodiments, the method further includes calculating an absolute quality value for at least one of the plurality of data points.

In exemplary embodiments, the converting step, the determining step, the calculating step, and the establishing step, as well as the various other steps disclosed herein, are performed with a computing device.

In another embodiment, the present disclosure provides a computer implemented statistical process control method. The method includes converting a plurality of data points to a plurality of Cartesian coordinate sets, determining a centroid for the plurality of Cartesian coordinate sets, calculating a distance from each of the plurality of Cartesian coordinate sets to the centroid, calculating an average distance and a standard deviation for the plurality of distances, and establishing an ellipsoidal control surface based on the standard deviation.

in some embodiments, the method further includes establishing a mean boundary based on the average distance. The mean boundary may, for example, have a radius equal to the average distance.

In some embodiments, the control surface has a radius equal to an average distance for the plurality of distances plus a total of the standard deviation times a deviation factor.

In some embodiments, the method further includes evaluating at least one of the plurality of data points based on a location of the data point relative to the control surface. In some embodiments, the method further includes calculating an absolute quality value for at least one of the plurality of data points.

In exemplary embodiments, the converting step, the determining step, the calculating steps, and the establishing step, as well as the various other steps disclosed herein, are performed with a computing device.

In another embodiment, the present disclosure provides a system for performing statistical process control. The system includes a display device, a processor, and a memory coupled to the processor. The memory includes computer-readable instructions for execution by the processor to cause the processor to perform operations. The operations include converting a plurality of data points to a plurality of Cartesian coordinate sets, determining a centroid for the plurality of Cartesian coordinate sets, calculating a distance from each of the plurality of Cartesian coordinate sets to the centroid, and establishing an ellipsoidal control zone based on the plurality of distances.

In some embodiments, the operations may further include any suitable step disclosed herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 shows a set of data points and radial and angular control limits as they might be established using a traditional statistical analysis method.

FIG. 2 shows the same set of data as FIG. 1, shifted towards the origin.

FIG. 3 shows the same set of data as FIG. 1, centered at the origin.

FIG. 4 shows one embodiment of the present invention.

FIG. 5 demonstrates the applicability of the present invention regardless of position with respect to the origin.

FIG. 6 shows the present invention reduced to practice in a software application in a computing device.

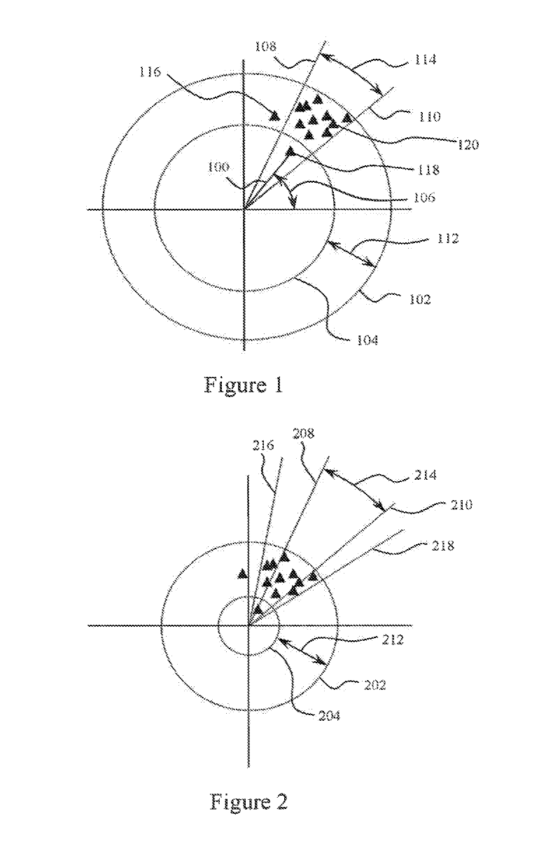

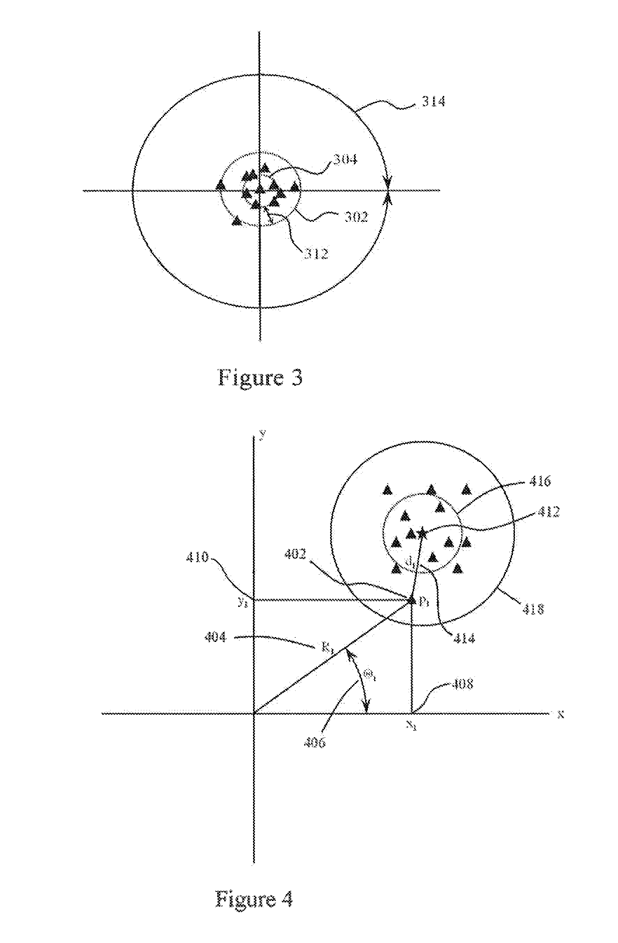

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

One embodiment of the method is shown in FIG. 4, where a set of polar data points are considered. Point p₁ 402, having radius R₁ 404 and angle Θ₁ 406, is converted to its equivalent Cartesian coordinates x₁ 408 and y₁ 410. It should be understood that, while two-dimensional x-y coordinate systems are illustrated, the present disclosure is not so limited. Rather, a Cartesian coordinate system according to the present disclosure includes x, y and z coordinates, as is generally understood. Accordingly, data points according to the present disclosure may be converted to equivalent x, y and/or z coordinates, and the resulting ellipsoidal control zone and the ellipsoidal control surface defining that control zone may be three-dimensional. In a similar fashion, all points in the data set are likewise converted to their Cartesian coordinates. A center-x coordinate, center-y coordinate, and/or center-z coordinate for the set of data points is then calculated to determine a center-location 412. The center-location 412 may be referred to as a centroid. Distance d1 414 is then calculated. as the distance from point p1 402 to center-location 412. In a similar fashion, Cartesian coordinates xₙ, yₙ, and/or zₙ are determined for the remaining polar data points in the set, and distances dₙ are calculated for each data point. The average distance, d_{Avg}, of all distances dₙ for the data set, and the standard deviation, σ_{dn}, of all distances dₙ are then calculated. Next, a mean sphere or other suitable ellipsoid, 416, having a radius d_{Avg} and emanating from the center-location 412 is constructed, and finally, one or more spherical or otherwise ellipsoidal control surfaces 418 is constructed, having a radius d_{Avg}+kσ_{dn}, and also emanating from the center location 412, where it is contemplated that k<=6, although other values could suffice and k need not be an integer.

Having established one or more control surfaces 418, a data point is then evaluated based on its location in space with respect to the control zone defined by the control surface(s). A point falling within the control zone or on the control surface is deemed to be “in-control”, and a point falling outside of the control zone is deemed to be “out-of-control”. Furthermore, an absolute quality value for each data point can be calculated by the quotient d_{Avg}/dₙ, the value 1.0 representing a point whose quality is exactly average, values less than 1.0 having under average quality, and values greater than 1.0 having above average quality, with quality approaching ideal quality as the quotient approaches infinity.

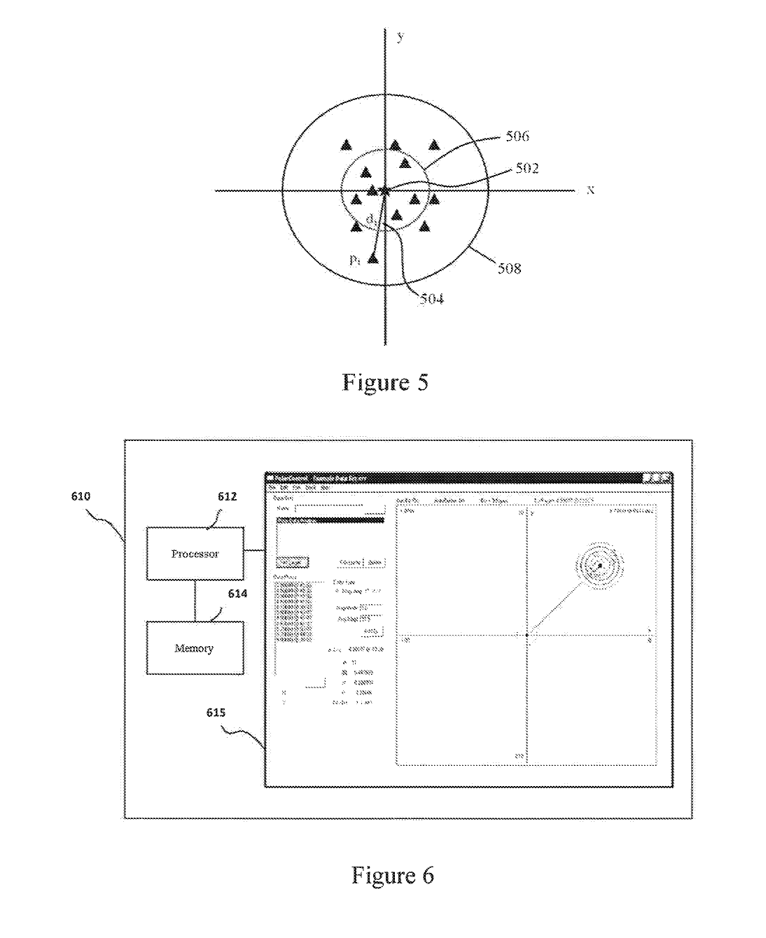

As shown in FIG. 5, when the data set is moved to the origin, the same method may be used to analyze the data points. The center-location 502 is calculated from Cartesian coordinates. Then the average distance and standard deviation of the distances 504 of the data points to center-location are calculated, from which we construct the mean ellipsoid 506 and the control surface 508 defining the control zone. We then determine which points are in-control or out-of-control based, again, on their position with respect to the control zone.

Data where one axis of a Cartesian space is more heavily weighted than the others can also be analyzed using this method. This can be done in one of two ways: by normalizing the weighted axis values prior to beginning the analysis, or by creating an ellipsoid control surface instead of a spherical control surface. The weighted, spherical control surface method is preferred by the inventor because of its uniformity of application when assigning a quality value based on the quotient d_{Avg}/dₙ.

This statistical method has applications in diverse fields, for instance: for determining the most cost-effective geographical marketing region for a product or group of products based on UPS coordinates of a particular demographic; for analyzing the accuracy of GPS equipment; for assessing the precision of ordinance; for evaluating performance in a dart throwing or sharp-shooting contest; for determining the fit of prostheses; for analyzing the influence of demographics on political polling data; for determining the regions of the cosmos most likely to sustain life; for assessing the contribution of variables in medical research; for analyzing reproducibility of color space data; for analyzing repeatability of a circular geometry inspection system or coordinate measuring machines; and many others.

The method has already been reduced to practice in a software application designed and developed by the inventor, as shown in FIG. 6, heretofore unpublished and undisclosed. Referring to FIG. 6 as well as FIG. 7, a computing device 610 may be utilized for performing statistical process control as discussed herein. The computing device 610 can take any appropriate form, such as a personal computer, smartphone, desktop, laptop, PDA, tablet, or other computing device. The computing device 610 includes appropriate input and output devices, such as a display screen, touch screen, touch pad, data entry keys, speakers, and/or a microphone suitable for voice recognition. A user can perform statistical process control in accordance with the present disclosure by, for example, inputting data points into computing device 610. The computing device 610 can then perform the various steps as disclosed herein and provide control zone information, data point evaluation information, absolute quality value information, etc. to the user through any suitable output device, such as a display screen 615.

The computing device 610 includes a processor(s) 612 and a memory 614. The processor(s) 612 can be an known processing device. Memory 614 can include any suitable computer-readable medium or media, including, but not limited to, RAM, ROM, hard drives, flash drives, or other memory devices. Memory 614 stores information accessible by processor(s) 612, including instructions that can be executed by processor(s) 612. The instructions can be any set of instructions that when executed by the processor(s) 612, cause the processor(s) 612 to provide desired functionality. For instance, the instructions can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to application-specific circuits.

Memory 614 can also include data that may be retrieved, manipulated, or stored by processor(s) 612. For instance, memory 614 can store data points, formulas, equations, and other suitable data required to perform the various steps as disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computer implemented statistical process control method, the method comprising:
converting a plurality of data points to a plurality of Cartesian coordinate sets;
determining a centroid for the plurality of Cartesian coordinate sets;
calculating a distance from each of the plurality of Cartesian coordinate sets to the centroid; and
establishing an ellipsoidal control zone based on the plurality of distances.

2. The method of claim 1, wherein the establishing step comprises calculating an average distance for the plurality of distances.

3. The method of claim 2, wherein the establishing step further comprises establishing a mean boundary based on the average distance.

4. The method of claim 3, wherein the mean boundary has a radius equal to the average distance.

5. The method of claim 1, wherein the establishing step comprises calculating a standard deviation for the plurality of distances.

6. The method of claim 5, wherein the establishing step further comprises establishing a control surface based on the standard deviation.

7. The method of claim 6, wherein the control surface has a radius equal to an average distance for the plurality of distances plus a total of the standard deviation times a deviation factor.

8. The method of claim 7, wherein the deviation factor is less than or equal to 6.

9. The method of claim 6, further comprising evaluating at least one of the plurality of data points based on a location of the data point relative to the control surface.

10. The method of claim 1, wherein the control zone is established based on an average distance and a standard deviation for the plurality of distances.

11. The method of claim 1, further comprising evaluating at least one of the plurality of data points based on the control zone.

12. The method of claim 1, further comprising calculating an absolute quality value for at least one of the plurality of data points.

13. The method of claim 1, wherein the converting step, the determining step, the calculating step, and the establishing step are performed with a computing device.

14. A computer implemented statistical process control method, the method comprising:
converting a plurality of data points to a plurality of Cartesian coordinate sets;
determining a centroid for the plurality of Cartesian coordinate sets;
calculating a distance from each of the plurality of Cartesian coordinate sets to the centroid;
calculating an average distance and a standard deviation for the plurality of distances; and
establishing an ellipsoidal control surface based on the standard deviation.

15. The method of claim 14, further comprising establishing a mean boundary based on the average distance.

16. The method of claim 15, wherein the mean boundary has a radius equal to the average distance.

17. The method of claim 14, wherein the control surface has a radius equal to an average distance for the plurality of distances plus a total of the standard deviation times a deviation factor.

18. The method of claim 14, further comprising evaluating at least one of the plurality of data points based on a location of the data point relative to the control surface.

19. The method of claim 14, further comprising calculating an absolute quality value for at least one of the plurality of data points.

20. A system for performing statistical process control, the system comprising:
a display device;
a processor; and
a memory coupled to the processor, the memory comprising computer readable instructions for execution by the processor to cause the processor to perform operations, the operations comprising:
converting a plurality of data points to a plurality of Cartesian coordinate sets;
determining a centroid for the plurality of Cartesian coordinate sets;
calculating a distance from each of the plurality of Cartesian coordinate sets to the centroid; and
establishing an ellipsoidal control zone based on the plurality of distances.
